(19) United States
(12) Patent Application Publication
(10) Pub. No.: US 2002/0081551 A1
(43) Pub. Date: Jun. 27, 2002

(54) Apparatus for filling a cavity of a cavity containing member such as a tooth or restorative dental piece

(75) Inventors: Gabriela Bopp, Gofis (AT); Andreas Radl, Schaan (LI); Bruno Senn, Buchs (CH); Gottfried Rohner, Altstatten (CH)

Correspondence Address: John C. Thompson, 69 Grayton Road, Tonawanda, NY, 14150, US

(73) Assignee: Ivoclar Vivadent AG;

(21) Appl. No.: 10/007,041

(22) Filed: Nov. 5, 2001

Related U.S. Application Data
(60) Provisional application No. 60/273,930, filed on Mar. 7, 2001.

(30) Foreign Application Priority Data
Dec. 21, 2000 (DE) P 100 64 005.2

(51) Int. Cl. A61C 5/04

(52) U.S. Cl. 433/89

(57) ABSTRACT

A cavity filling apparatus is provided for filling a cavity in a cavity containing member such as a tooth and a restorative dental piece. The cavity filling apparatus includes a filling mass ready space for retaining therein a filling mass, a suction conduit, and an adapter having an adapter channel. In a suction disposition of the cavity filling apparatus, a vacuum is produced in the cavity of the cavity containing member, via the adapter channel, by suction action through the suction conduit. In connection with a filling disposition of the cavity filling apparatus, the filling mass is injected into the cavity, via the adapter channel, from the filling mass ready space. The cavity filling apparatus also includes an assembly for switching the cavity filling apparatus between its suction disposition and its filling disposition.

### BACKGROUND OF THE INVENTION

The present invention relates to an apparatus for filling a cavity of a cavity containing member such as a tooth or a restorative dental piece.

A cavity filling apparatus for filling teeth cavities has been proposed which comprises a suction conduit communicable with the cavity to thereby apply a vacuum to the cavity. A filling mass which is retained in a filling mass ready space between the suction conduit and a lever positioned above the suction conduit is moved into the cavity upon actuation of the lever.

This approach has not been comprehensively deployed in practice for the reason that the filling mass ready space realistically must be practically located in the extension of the filling channel which thus necessitates a correspondingly large assembled dimension. Additionally, the actuation lever is still arranged above the filling mass ready space so that only through skill can the dentist effect the desired actuation of the lever. This arrangement also brings with it the complication that there is a projecting lever which acts as an obstacle and which is not well suited for the patient's mouth and, further, it cannot be completely prevented that the tongue of the patient may unintentionally and involuntarily prematurely actuate the actuation lever.

It has further been proposed in DE-OS 40 11 568 to fill, in particular, a crown of a tooth via a cavity filling apparatus. This approach is expected to insert the filling material to the deepest possible extent into the root canals. This approach in fact sets the filling inserter under a vacuum so that the filling mass can be inserted in a non-air entraining manner. However, the cavity itself is merely at the pressure of the surroundings so that it is very difficult to avoid entrainment of air in the filling mass during the cavity filling process. The filling inserter, in particular, must be controlled as it is withdrawn from the root canal while, at the same time, the amount of the filling material deposited must be precisely controlled in a manner coordinated with the withdrawal movement of the filling inserter.

It is therefore not surprising that this just described approach is not comprehensively deployed in practice.

### SUMMARY OF THE INVENTION

The present invention provides a cavity filling apparatus which advantageously provides greater ease of use and is secured against disturbances while nonetheless engendering an improved acceptance of such an approach by the patients.

The cavity filling apparatus of the present invention offers the particular advantage that it engenders improved acceptance by patients because it provides a non-air entraining cavity filling process. In order to make it possible that the adapter of the cavity filling apparatus has only a relatively small height above the bore used for the filling, the cavity filling apparatus of the present invention permits initially also filling the molars on their chewing surface side. Since a special actuation of a projecting lever must be performed, the tendency of the dentist to tilt or angle the adapter in actuating the mechanism which switches between the suction and filling dispositions is strongly reduced, whereby the danger that air is suctioned in and thereby causes air entrainment in the filling material is practically foreclosed.

The cavity filling apparatus of the present invention permits switching over from the suction disposition to the filling disposition with a natural movement—namely, an increase of the force on the tooth or the restorative dental piece to be filled without necessitating a special hand disposition or an added hand movement of the dentist.

It is to be understood that while the force exerted on the cavity filling apparatus during the evacuation phase of the filling process as well as the force exerted to effect switching between the suction and filling dispositions is, in a wide range of situations, tailored to the requirements of the task, these forces can also be tailored to the preferences of the individual dentist. It is preferable to provided a modest seating function for the switching mechanism which indicates clearly that the switching has occurred. For example, the force required for switching can be set as triple that of the normal force on the adapter which is applied during the evacuation phase.

In an advantageous embodiment of the cavity filling apparatus of the present invention, the switch over force is actuated automatically without other intervention by dimensioning the sealing rings of the working body portion which acts against the guide socket of the working body portion. To place in readiness a large actuation force for effecting the switching over between the suction and filling dispositions, it is possible to use O-rings with an increased strength and, to place in readiness a lower actuation force, to use O-rings with a reduced strength. Moreover, the frictional force with respect to the seating force can in any event be finely adjusted through corresponding configuration of the seating groove. It is preferably provided that two seals are disposed axially spaced from one another on a cylindrical working body in the guide socket, each of which respectively seats in a corresponding annular groove in accordance with the position of the working body. The edge steepness of the annular groove determines then the pure switch over force.

In accordance with a particularly advantageous aspect of the present invention, solely a single adapter channel is provided in the adapter which is deployed as both a suction passage as well as a filling material passage. This solution offers a markedly reduced frequency of disturbances in comparison to solutions having two concentric canals, although also a reduction in the production effort. In accordance with the present invention, the working body itself forms a switchover flank, whereby, in a first disposition of the working body (the suction disposition of the cavity filling apparatus), a filling inlet of the filling mass ready space is closed off by the working body or, more precisely, by the switchover flank. In contrast, in a second disposition of the working body (the filling disposition of the cavity filling apparatus), a working opening of the adapter channel can be oriented toward the filling inlet in the most obstacle-free manner so that the filling mass can enter the adapter channel in a blockage-free manner and pass from there into the cavity.

In accordance with the present invention, it is particularly advantageous if the viscosity of the filling mass is exploited for the purpose of keeping the filling mass free from entrained air. Although as a basic premise the filling of the filling mass ready space would be possible by pressing movement of an injector head, in accordance with the present invention, an integral suctioning or drawing of the filling mass is preferable. In this connection, a small yet nonetheless defined gap is provided in the working area between the working body and the guide socket. Air is drawn into this gap from a suction coupling which is immediately adjacent the filling mass ready space and extends perpendicularly therefrom and the drawn in air then travels out of the adapter channel and into the cavity of the tooth or the restorative dental piece. At the same time, air is drawn through the gap between the switch over angle and the filling inlet so that a vacuum is produced in the filling mass ready space. Since the cavity forms an enclosed space with the adapter channel when the channel is firmly communicated therewith, further suctioning via the suction conduit produces a vacuum in the filling mass ready space and this vacuum acts to draw in a filling mass which has been pre-positioned in an injector until the filling mass borders on the filling inlet. As soon as this occurs, the vacuum in the adapter channel increases and the vacuum increases as well in the suction conduit so that it is possible to detect via a pressure detector when the adapter is ready for a switchover from the suction disposition to the filling disposition.

In accordance with the present invention, it is particularly advantageous if the vacuum produced in the cavity acts to draw the adapter thereagainst. The seal between the adapter and the cavity is for this reason not critical, whereby it is advantageous if the angle of an outer cone on the adapter is selected such that the adapter maintains itself in communication with the tooth or the restorative dental piece after it has initially been disposed thereon.

In an especially advantageous embodiment of the cavity filling apparatus of the present invention, a static mixer is provided through which pass the two components which comprise the filling mass. In accordance with the present invention, this occurs via the heretofore described suction force so that the components are at the same time free of entrained air. The static mixer can be configured as a spiral threaded component which is received in a cylinder having an inner diameter sized in correspondence with the outer diameter of the spiral. An intensive mixing of the two components with one another occurs due to the suctioning of the filling mass for the reason that the filling mass, which tends to follow the spiral passage, is at the same time subject to shearing during its passage due to the fact that suitable measures such as a rotation preventing securement member are provided to ensure that the injector connecting component, in which the spiral threaded component is disposed, does not rotate.

The cavity filling apparatus of the present invention lends itself to an especially cost favorable manufacturing thereof. The guide socket which collectively comprises the filling mass ready space and the adapter body can also be manufactured as a single unit. It is also possible to releasably dispose the adapter body in the guide socket so that a cleaning can be facilitated.

In a further particularly advantageous embodiment of the invention, it is provided that an additional coupling is also located adjacent the suction coupling on the guide socket for the purpose of measuring the respective vacuum.

Additional advantages, details, and features are set forth in the following description in connection with the figures of the drawings.

### BRIEF DESCRIPTION OF THE DRAWINGS

FIG. 1 is an exploded perspective view of one embodiment of the cavity filling apparatus of the present invention;

FIG. 2 is a perspective view of the one embodiment of the cavity filling apparatus shown in FIG. 1 prior to its assembled together condition;

FIG. 3 is another perspective view of the one embodiment of the cavity filling apparatus shown in FIG. 1 in its assembled together condition;

FIG. 4 is a perspective view of the one embodiment of the cavity filling apparatus shown in FIGS. 1-3;

FIG. 5 is an enlarged perspective view of portions of the one embodiment of the cavity filling apparatus shown in FIGS. 1-3;

FIG. 6 is an enlarged cross-sectional view of portions of the one embodiment of the cavity filling apparatus shown in FIG. 1;

FIG. 7 is an enlarged sectional view of the working unit portion of the one embodiment of the cavity filling apparatus shown in FIG. 1 and showing the working unit portion in the suction disposition of the cavity filling apparatus; and

FIG. 8 is an enlarged sectional view of the working unit portion of the one embodiment of the cavity filling apparatus shown in FIG. 1 and showing the working unit portion in the filling disposition of the cavity filling apparatus.

### DETAILED DESCRIPTION OF THE PREFERRED EMBODIMENT

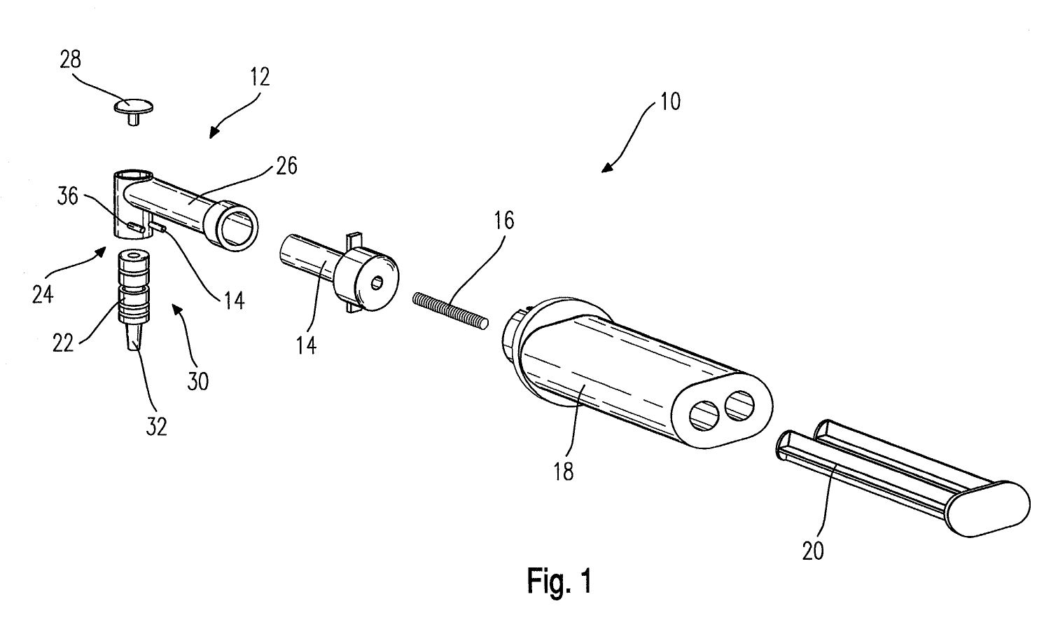

As seen in FIG. 1, the cavity filling apparatus 10 of the present invention includes a working unit portion 12, an injector connecting component 14, a static mixer 16, an injector cylinder component 18 and a double injector plunger 20. When deployed, these components are in the assembled together disposition shown in FIG. 3 and these components are shown in the exploded unassembled disposition in FIG. 1 for the sake of clarity of understanding.

The working unit portion 12 comprises a working body 22, a guide socket 24 in which the working body 22 is slidably received, and a filling space 26.

The working body 22 further includes an actuation cap 28 which retains the working body in the guide socket 24. The working body 22 forms together with the actuation cap 28 an adapter 30 and includes on its lower end an adapter cone 32. The adapter cone 32 is configured for insertion into a bore in a tooth or restorative dental piece which can itself be conically shaped with a cone angle corresponding to that of the adapter cone 32.

The guide socket 24 is configured of minimal length and is integrally built as a single unit with the filling space 26, whereby the filling space 26 is formed substantially as a pipe which extends outwardly from the guide socket.

A suction coupling 34, whose function will be described in more detail below, and a pressure measurement coupling 36 are disposed below the filling space 26.

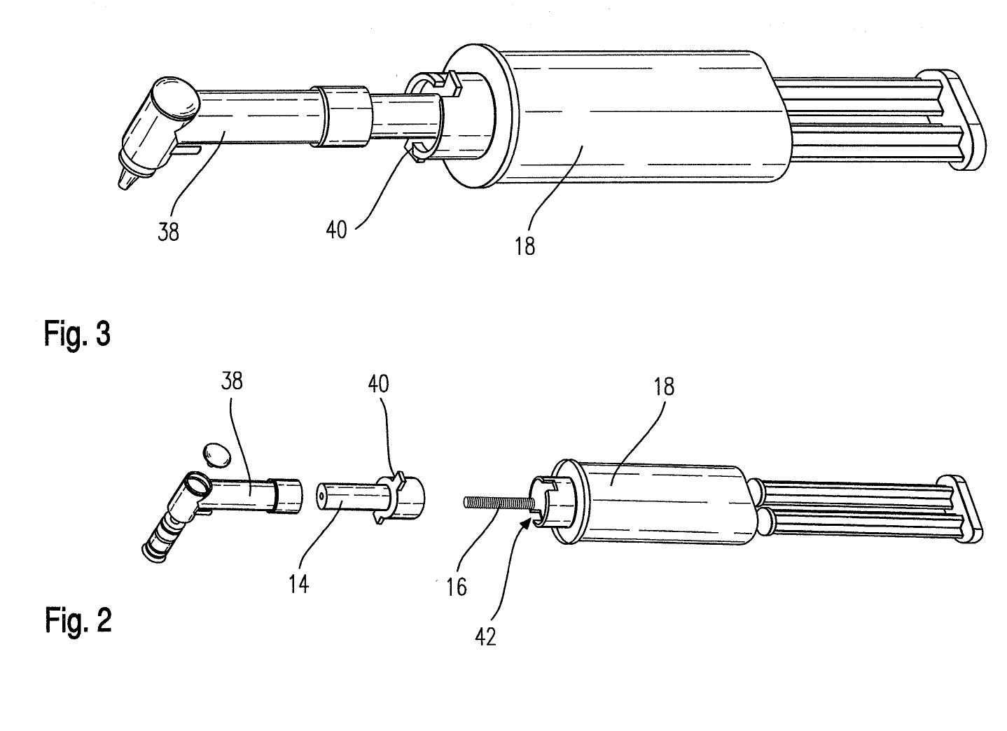

As can be readily seen in FIG. 2, the injector connecting component 14 can be partially inserted into the pipe 38 which forms the filling mass ready space 26. A rotation preventing securement member 40, provided on the outer periphery of the injector connecting component, engages corresponding tabs 42 of the injector cylinder component 18. A static mixer 16, which is in the shape of a spiral threaded component, is disposed in the injector connecting component 14 before the assembling together of the injector connecting component. The injector cylinder component 18 includes two cylinders, shown in FIG. 1, which are each filled with a material component to be mixed and injected. The filling mass in the filling mass ready space 26 is formed by the intensive mixing of the two material components with one another.

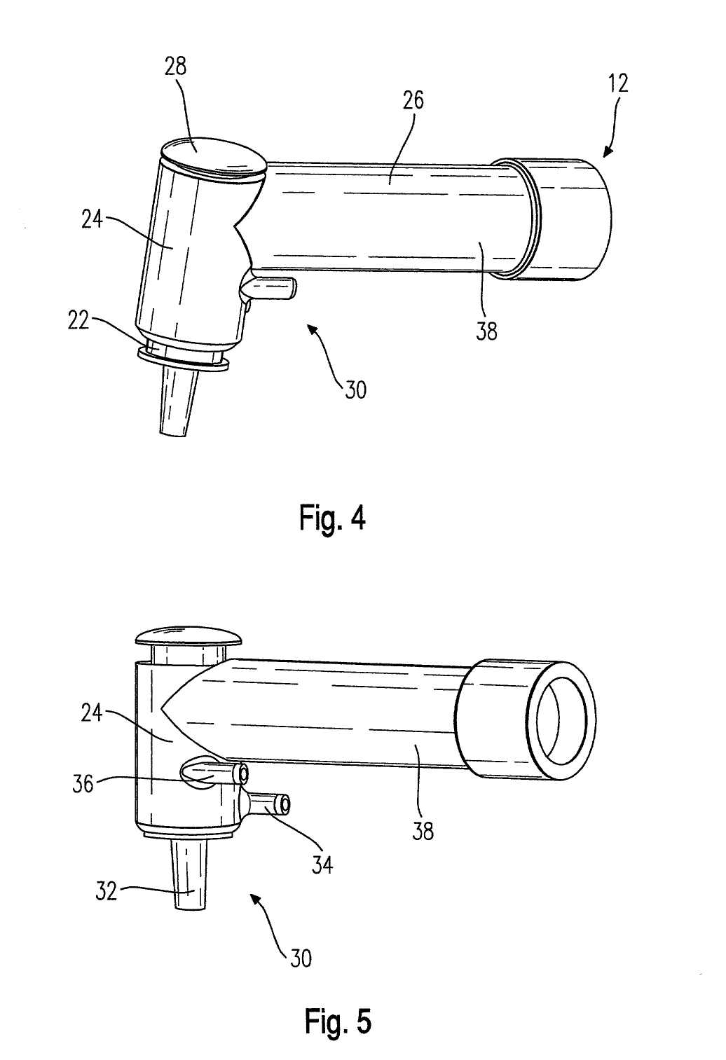

The working unit portion 12 is shown in an enlarged view in FIGS. 4 and 5. FIG. 4 shows the suction position of the adapter 30 in the guide socket 24 and FIG. 5 shows the filling position of the adapter in the guide socket. In the suction position of the adapter 30, the actuation cap 28 is in a flat contact position on the top side of the guide socket 24. In this position, the working body 22 is projected clearly downwardly.

In contrast, the working body 22 extends outwardly above the guide socket 24 in the filling position while solely the adapter cone 32 projects downwardly.

In connection with the transition between the suction position shown in FIG. 4 and the filling position shown in FIG. 5, it is sufficient if the dentist exerts from above a total downward force on the pipe 38 of the filling mass ready space 26. A transformer device 35 is configured for this purpose.

As can be seen in particular in FIG. 5, the pressure measurement coupling 36 and the suction coupling 34 extend in differing vertical planes as well as at an offset from one another. These couplings can be disposed at the smallest possible assembled height and, to ensure that the two couplings 34 and 36 each extend sideways adjacent the pipe 38, the two couplings can be conducted parallel to the pipe 38 out of the mouth of the patient.

Conduits which are not illustrated form a connection to a supply unit.

The pipe 38 includes—as can be seen in particular in FIG. 5—a rotation preventing securement member 40 which receives and supports therefrom the injector connection body 14. It is to be understood that a coupling without free play and, as desired, corresponding sealing members can be provided.

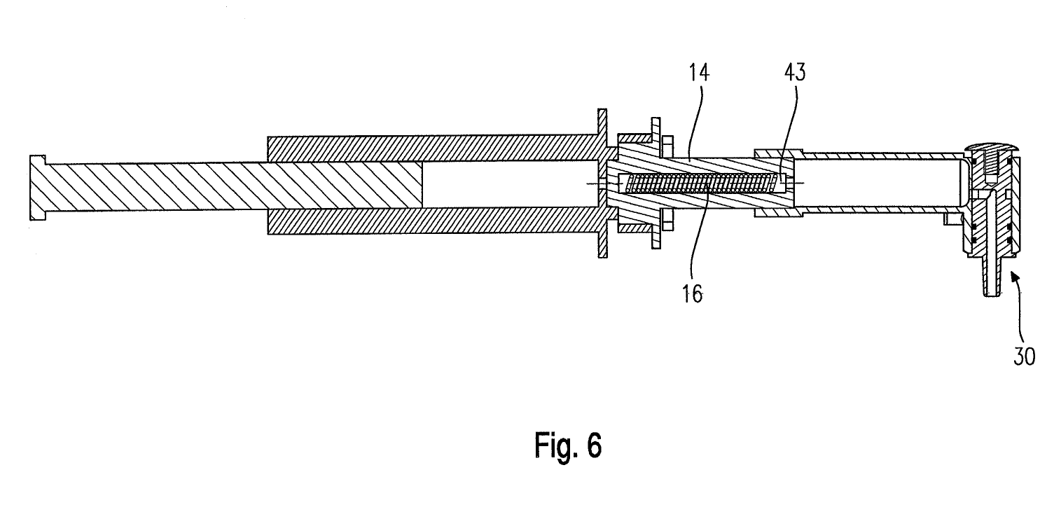

A cavity filling apparatus of the present invention is shown in FIG. 6 in a disposition in which the adapter 30 is disposed for administering a filling dose. It can be seen that the static mixer 16 practically completely fills a cylindrical inner volume 43 of the injector connection body 14. The static mixer 16 is so configured that it rests on the inner volume 43 under a resilient bias yet can be removed as required for, for example, the purpose of cleaning.

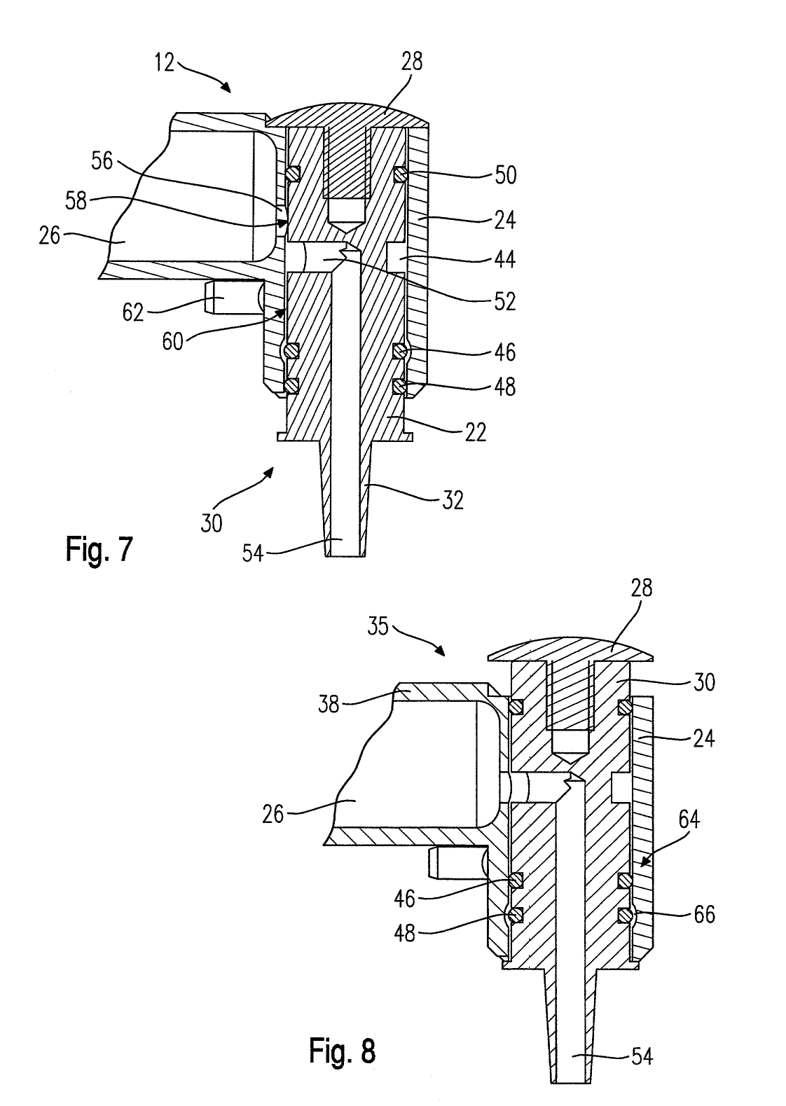

FIG. 7 shows the individual elements of the adapter 30 as they are assembled into assembled condition in the guide socket 24. The working body 22 of the adapter 30 is substantially cylindrical but nonetheless includes a not insubstantial annular groove 44 disposed slightly above the middle of the working body. The working body 22 further includes a first seal 46, a second seal 48, and a third seal 50, each of which is configured as an O-ring seal. The seals 46, 48, and 50 seal off the guide socket 24. The rotational position of the working body 22 within the guide socket 24 is set by a rotation preventing securement member (not illustrated). The working body 22 further includes a working opening 52 which is communicated with the annular groove 44 and extends toward the filling mass ready space 26 into communication with an adapter channel 54. The adapter channel extends through the entirety of the working body 22 as well as the adapter cone 32.

The filling mass ready space 26 terminates in a filling coupling 56 which extends toward the working body 22. As shown in FIG. 7, the filling coupling 56 in the suction position of the working body 22 is closed off by the transformation edge 58 of the working body while, as shown in FIG. 8, the filling coupling 56 in the filling position is open to the adapter channel 54.

A gap 60 of a predetermined width extends between the working body 22 and the guide socket 24. The suction coupling 62 is communicated with the gap 60 such that a vacuum exists in the gap and from there into other regions. The vacuum extends into the annular groove 44 and via the groove into the adapter channel 54. Since the seal 50 in the suction position shown in FIG. 7 is above the filling coupling 56, the vacuum extends as well into the filling coupling 56 and from there into the filling mass ready space 26. This leads to the condition that a filling mass, which is not shown, is drawn in by the vacuum condition to be disposed at the transformation edge 58. The viscosity of the filling mass is sufficiently large that it cannot enter into the gap 60 so long as the working body 22 remains in the suction position.

The suction position as shown in FIG. 7 is maintained for a predetermined period such as, for example, five minutes or more, to permit the evacuation of the cavity or hollowed out space in the tooth or the restorative dental piece. In this connection, the cavity and the adapter channel 54 are initially evacuated, whereby a remainder pressure of from 10 to 15 mbar remains automatically without further intervention. The vacuum propagates through the filling mass ready space 26 and effects a drawing in of the filling mass from the injector through the static mixer 16 into the filling mass ready space 26 until this space is filled. As soon as the filling mass ready space 26 is filled, no further air remains to be evacuated, whereby a suction occurrence is precluded. The dentist then presses from above on the pipe 38 so that the filling position shown in FIG. 8 is achieved. The switch over permits the filling mass to be injected from the filling mass ready space 26 through the adapter channel 54 into the cavity in the tooth. Thereafter, as a stronger vacuum ensues, the filling space is filled in a complete and air entrapment-free manner.

An inventive seating apparatus 64 is provided to make available a fixed transformation or switch over position. The seating apparatus 64 includes an annular groove 66 located in the interior of the guide socket 24 which cooperates with the first seal 46 and the second seal 48. In the first position, which is the suction position as shown in FIG. 7, the first seal 46 is seated in the annular groove 66. In this position, the first seal 46 is freely positioned and the vacuum existing in the gap 60 can be measured, whereby the measurement is conducted via the pressure measurement coupling 36.

For the transformation or switch over of the adapter 30 into the second position, which is the filling position, shown in FIG. 8, initially the first seal 46 is displaced out of its seated position in the annular groove and, upon further displacing movement, the second seal 48 seats in the annular groove 66.

The spacing between the seals 46 and 48 is selected such that the spacing is greater than the width of the annular groove 66, whereby a constant vacuum sealing is ensured in the interior of the working unit portion 12.

The actuation cap 28 is—as shown in FIGS. 7 and 8—threaded into a corresponding threaded receiving portion of the working body 22. To permit cleaning of the working body 22 and the working unit portion 12, the actuation cap 28 is released from its threaded retention so that the working body 22 can be withdrawn downwardly out of the guide socket 24. The actuation cap 28 is ball shaped for ease of reconfiguring the cavity filling apparatus from the filling position shown in FIG. 8 into the suction position shown in FIG. 7 in preparation for the filling thereof for the next tooth filling operation.

The specification incorporates by reference the disclosure of German priority document 100 64 005 2.

The present invention is, of course, in no way restricted to the specific disclosure of the specification and drawings, but also encompasses any modifications within the scope of the appended claims.

What is claimed is:

1. A cavity filling apparatus for filling a cavity in a cavity containing member which is a selected one of a tooth and a restorative dental piece, comprising:
means forming a filling mass ready space for retaining therein a filling mass which is to be subsequently inserted into the cavity of the cavity containing member;
a suction conduit;
an adapter having an adapter channel, the adapter channel being locatable in communication with the cavity of the cavity containing member and, in connection therewith, being selectively communicable with the filling mass ready space and the suction conduit in a suction disposition of the cavity filling apparatus in which one end of the adapter channel is in communication with the cavity of the cavity containing member, an opposite end of the adapter channel is in communication with the suction conduit, and a vacuum is produced in the cavity of the cavity containing member, via the adapter channel, by suction action through the suction conduit and, in connection with a filling disposition of the cavity filling apparatus in which the one end of the adapter channel is in communication with the cavity of the cavity containing member and the opposite end of the adapter channel is in communication with the filling mass ready space, the filling mass is injected into the cavity, via the adapter channel, from the filling mass ready space; and
means for switching between the suction disposition of the cavity filling apparatus and the filling disposition of the cavity filling apparatus, the switching means including means for movably retaining the adapter and the switching means being operable, when the adapter channel is in communication with the cavity of the cavity containing member, to switch the cavity filling apparatus from its filling disposition to its suction disposition in response to relative movement between the adapter and the movably retaining means in a first direction and to switch the cavity filling apparatus from its suction disposition to its filling disposition in response to relative movement between the adapter and the movably retaining member in a direction opposite to the first direction.

2. A cavity filling apparatus according to claim 1 and further comprising a filling coupling communicated with the filling mass ready space in the filling position and wherein the adapter includes a working body having a working opening which, when the switching means has switched the cavity filling apparatus into the filling disposition, is in communication with the filling coupling and, when the switching means has switched the cavity filling apparatus into the suction disposition, is out of communication with the filling coupling.

3. A cavity filling apparatus according to claim 2 wherein the movably retaining means includes a guide socket in which the working body is reversibly movably received such that the working body moves in one direction relative to the guide socket when the switching means switches from the suction disposition to the filling disposition, and the working body moves in another direction relative to the guide socket when the switching means switches from the filling disposition to the suction disposition.

4. A cavity filling apparatus according to claim 3 wherein the working body and the guide socket are configured relative to one another to form a gap therebetween dimensioned to permit an evacuation of the filling mass ready space by the application of a vacuum via the gap yet sufficiently constrictive to preclude the penetration through the gap of the filling mass retained in the filling mass ready space.

5. A cavity filling apparatus according to claim 1 wherein the cavity in the cavity containing member is externally communicated via a bore and the adapter includes an outer cone compatibly configured with respect to the bore.

6. A cavity filling apparatus according to claim 1 wherein the adapter includes a seal disposed on the adapter for contacting the cavity containing member to thereby provide sealing between the adapter and the cavity containing member.

7. A cavity filling apparatus according to claim 2 wherein the working body and the guide socket are configured relative to one another to form a cylindrical gap therebetween, the cylindrical gap extending at least between the mouth of the suction conduit and the filling coupling, and further comprising a pair of seals each of which sealingly bounds a respective opposite axial end of the cylindrical gap.

8. A cavity filling apparatus according to claim 2 wherein the adapter includes an actuation cap and the movably retaining means includes a guide socket in which the working body is reversibly movably received such that the working body moves in one direction relative to the guide socket when the switching means switches the cavity filling apparatus from the suction disposition to the filling disposition, and the working body moves in another direction relative to the guide socket when the switching means switches the cavity filling apparatus from the filling disposition to the suction disposition, the actuation cap is disposed on one axial end of the working body adjacent the filling mass ready space, and the application of an axial force on the actuation cap effects movement of the working body relative to the guide socket such that, in the suction position, the working body blocks the filling coupling from communication with the filling mass ready space.

9. A cavity filling apparatus according to claim 3 wherein the adapter includes an annular groove formed on the periphery of the working body, a first seal extending circumferentially about the working body, a second seal extending circumferentially about the working body at a location thereon axially spaced from the first seal, whereby the first seal sealingly seats in the annular groove in the suction disposition and the second seal sealingly seats in the annular groove in the filling disposition.

10. A cavity filling apparatus according to claim 2 and further comprising a static mixer connected to the filling mass ready space on the side of the filling mass ready space on which the filling coupling is communicated, the static mixer being operable to mix together two material components into a filling mass.

11. A cavity filling apparatus according to claim 10 wherein the static mixer is operatively connected to a double injector which is movable in response to a vacuum in the filling mass ready space to press the two material components into mixing travel through the static mixer.

12. A cavity filling apparatus according to claim 10 wherein the static mixer is in the form of a spirally shaped threaded member disposed in a cylindrical tube which is communicated with the working body, and the static mixer includes a rotation preventing securement member for securing the cylindrical tube to the working body in a manner which prevents rotation of the static mixer relative to the working body.

13. A cavity filling apparatus according to claim 12 wherein the working body and the guide socket are collectively oriented at an angle to the filling mass ready space and at an angle to the static mixer.

14. A cavity filling apparatus according to claim 2 wherein the adapter includes an actuation cap and the movably retaining means includes a guide socket in which the working body is reversibly movably received such that the working body moves in one direction relative to the guide socket when the switching means switches from the suction disposition to the filling disposition, and the working body moves in another direction relative to the guide socket when the switching means switches from the filling disposition to the suction disposition, the actuation cap is disposed on one axial end of the working body and limits axial movement of the working body relative to the guide socket, and the actuation cap is removably secured to the working body such that removal of the actuation cap permits subsequent removal of the working body from its disposition in the guide socket for cleaning purposes.

15. A cavity filling apparatus according to claim 3 wherein the guide socket includes an annular groove and the switching means includes a pressure measurement coupling connected to the guide socket and communicated with the annular groove whereby the vacuum produced in the suction position of the cavity filling apparatus is measurable via the annular groove and the pressure measurement coupling.

16. A cavity filling apparatus according to claim 1 and further comprising an injector for injecting a filling mass into the filling mass ready space.

17. A method for filling a cavity of a cavity containing member which is a selected one of a tooth and a restorative dental piece, comprising:
providing a cavity filling apparatus having a means forming a filling mass ready space for retaining therein a filling mass which is to be subsequently inserted into the cavity of the cavity containing member, a suction conduit, an adapter having an adapter channel, the adapter channel being locatable in communication with the cavity of the cavity containing member and, in connection therewith, being selectively communicable with the filling mass ready space and the suction conduit in a suction disposition of the cavity filling apparatus in which one end of the adapter channel is in communication with the cavity of the cavity containing member, an opposite end of the adapter channel is in communication with the suction conduit, and a vacuum is produced in the cavity of the cavity containing member, via the adapter channel, by suction action through the suction conduit and, in connection with a filling disposition of the cavity filling apparatus in which the one end of the adapter channel is in communication with the cavity of the cavity containing member and the opposite end of the adapter channel is in communication with the filling mass ready space, the filling mass is injected into the cavity, via the adapter channel, from the filling mass ready space, and means for switching between the suction disposition of the cavity filling apparatus and the filling disposition of the cavity filling apparatus, the switching means including means for movably retaining the adapter and the switching means being operable, when the adapter channel is in communication with the cavity of the cavity containing member, to switch the cavity filling apparatus from its filling disposition to its suction disposition in response to relative movement between the adapter and the movably retaining means in a first direction and to switch the cavity filling apparatus from its suction disposition to its filling disposition in response to relative movement between the adapter and the movably retaining member in a direction opposite to the first direction;
disposing the adapter channel in communication with the cavity of the cavity containing member;
relatively moving the adapter and the movably retaining means in the first direction whereby, in response thereto, the switching means switches the cavity filling apparatus into its suction disposition and the suction produced thereby is applied into the cavity of the cavity containing member via the adapter channel and also draws a filling mass into the filling mass ready space; and
following the filling of the filling mass ready space with the filling mass, relatively moving the adapter and the movably retaining means in the direction opposite the first direction whereby, in response thereto, the switching means switches the cavity filling apparatus from its suction disposition into its filling disposition in which the filling mass is injected via the adapter channel from the filling mass ready space into the cavity.

18. A method according to claim 17 wherein the step of relatively moving the adapter and the movably retaining means in the first direction includes applying a force to the movably retaining means.

19. A method according to claim 17 and further comprising measuring the vacuum in the adapter and relatively moving the adapter and the movably retaining means in the direction opposite the first direction in response to the detection of a vacuum which occurs upon the filling of the filling mass ready space with the filling mass.
